(19) United States
(12) Patent Application Publication
(10) Pub. No.: US 2010/0244455 A1
(43) Pub. Date: Sep. 30, 2010

(54) Renewable energy electric power generation system derived from mechanical sources

(76) Inventor: MICHAEL J. BERGINC, TARPON SPRINGS, FL (US)

Correspondence Address: MICHAEL J. BERGINC, 749 HAVEN PLACE, TARPON SPRINGS, FL, 34689, US

(21) Appl. No.: 12/725,048

(22) Filed: Mar. 16, 2010

Related U.S. Application Data
(60) Provisional application No. 61/211,147, filed on Mar. 30, 2009.

(51) Int. Cl. F03D 9/02

(52) U.S. Cl. 290/55

(57) ABSTRACT

A renewable energy generating system includes one or more alternating current or direct current generating systems with collection devices to capture renewable energy from the venting, exhaust, flow and/or wind generated from mechanical driven powered sources. The renewable energy generating system will collect renewable energy from any and all mechanical venting, flow, exhaust, or wind such as but not limited to pumps, air conditioner exhaust, exhaust fans or any other directed mechanically generated sources. Power from the said generating system with collection devices is stored in a bank of electrical storage devices or sent directly to the electrical power panel or reentered directly to the mechanical source to reduce the energy pulled for its operation. The system operates at any and all times the mechanical source is in operation. The energy power generating system generates power on a continuous twenty-four hour cycle if the said mechanical source is operating. When this renewable energy system is incorporated together the mechanical source of all dwellings, buildings and other structures the collective devices have the capacity to create the largest wind field in the world and the most environmentally efficient renewable energy source in the world. By eliminating large power plants, the power lines needing to be established and the immediate return of energy directly to the power grid will become the most efficient power source in the world. Each renewable energy generating system will be either retrofitted to or incorporated with the said mechanical source to extract the most efficient renewable energy collection available.

Renewable energy electric power generation system derived from mechanical sources.

### CROSS-REFERENCED TO RELATED APPLICATIONS

### BACKGROUND OF THE INVENTION

The present invention is directed toward a renewable energy electric power generating system and, more particularly, toward an integrated renewable energy system comprised of either alternating current or direct current wind turbines and the regenerative electric energy captured from mechanical source never before used or adapted for this novel energy capture and renewable energy system. This renewable energy electric power generating system will reduce the demand for energy by capturing the exhaust, wind, venting or discharge from mechanical sources such as air conditioners, hood vent systems and the like, but not limited to only those examples. This renewable energy generated is routed directly to the mechanical source or to the power grid to be used as immediately electricity. Adapting this novel collection and reenergizing system, this invention eliminates all of the excess wiring of other previous inventions, such as wind mills and the like; not requiring the extra expenses and intrusions of power lines, transfer stations, environmental impact and other such obstacles.

The world is facing a major energy, clean air, and a financial challenge. Renewable energy systems using wind, sun, and water utilizing advanced energy generating technology offer potential solutions; unfortunately, the current state of the art of conventional wind turbine generators, energy storage systems, technologies have individually not been fully developed from a stand point of efficiency and cost effectiveness to meet the challenge. They also incur an environmental impact, such as wind fields which require large expanses of land, lead to wild animal deaths (birds flying into blades), excessive power lines for transmission of generated energy, along with the power collection stations required to house this energy. This renewable energy electric power generating system source of renewable energy has not been tapped or exploited. The renewable energy electric power generating system consistent availability of renewable energy at every location of said source and not limited to every corner and level from households to giant building complexes where the venting of wind, flow, exhaust or discharge takes place due to their use of mechanical sources as mentioned previously.

Current wind turbines for utility use are huge machines that use conventional generator designs that include troublesome gear systems and lack of a commercially viable energy recovery system. The renewable energy electric power generating system returns the renewable energy back to the mechanical source or directly to the power grid immediately. This novel system when adapted to each available mechanical system will create the largest wind field with the lease obtrusive foot print ever envisioned.

### SUMMARY OF THE INVENTION

The wind turbines are being recognized as a low cost generator of renewable energy. However, the economic potential of a low cost renewable energy wind turbine from a mechanical source has not been exploited. In order to optimize wind turbine system efficiency, a number of supporting subsystems are required. This energy generating system compensates for the effects of variable and intermittent winds which other wind systems count on to generate power. With the venting flow, exhaust and or discharge from a mechanical source and the renewable energy output will remain constant when the mechanical source is in operation. This integrated system is specifically designed to operate on a managed day/night or 24 hour cycle. The regenerative system generates electricity any time during the day or night when the mechanical sources are in operation.

This system does not require a storage system, the energy created will flow back to the mechanical system by wiring or directly to grid. However, an energy storage system can be used and will hold the energy created or release the energy directly to the electrical grid. The energy storage system will be large enough to handle the energy output created by the electric energy generating system and use the renewable energy as needed or returned to the power grid..

### DETAILED DESCRIPTION OF THE INVENTION

The present invention is a concept for meeting the Worlds enormous energy demand through the use of an extreme green environment electric generating technology utilizing renewable energy which will not plane a carbon foot print and will be a complete non-polluting system. The concept consists of energy technologies that are uniquely integrated so as to significantly enhance their overall efficiency for the production of electric power.

A turbine generator captures the energy created from the venting, flow, discharge, exhaust, or wind created all mechanical source, this generator is positioned above the vented flow at a distance to be the most efficient renewable energy collection setting and which turns the fan blades that in turn rotates the turbine from the said discharge and creates renewable energy.

The renewable energy is collected by a turbine generator which is Either retrofitted over the top of the said discharge area or incorporated as part of the mechanical source during the manufacturing stage to collect the discharge from the device and creates renewable energy at a distance above said mechanical source discharge to maximize the renewable turbine generators maximum efficiency.

The renewable energy collection turbine will return the renewable energy directly to the mechanical source, to an energy collection system such as battery bank or the like or directly to the power grid through internal connected wiring. If using a direct current generator or in to an electric power grid connector with an energy back flow preventer to inhibit energy loss. This will immediately add the new renewable energy to affect power usage in real time. With each running cycle of the mechanical source the output remains constant and will deliver to the generator system a constant flow, wind, exhaust or discharge to make energy at a stable rate.

The renewable energy is generated any time the mechanical forces in operation. The renewable energy coming from the collection turbine does not require major power lines or energy transfer stations and creates the largest renewable energy field with the least expense to economic and physical detriment to the environment when the system is retrofit or incorporated to the said mechanical source.

### BRIEF DESCRIPTION OF THE DRAWINGS

For the purpose of illustrating the invention, there are shown in the accompanying drawings forms that are presently preferred; it being understood that the invention is not intended to be limited to the precise arrangements and instrumentalities shown.

FIG. 1 Is a perspective of the generator with fan attached and the wiring from the generator along with the housing structure to provide support to the generator and protection from the spinning fan blades.

FIG. 2 is a perspective of the side view of the generator and fan blades with the housing support and protector before they are combined as the protective housing goes over top of the generator and fan blades and held securely to the top of the housing support by fasteners.

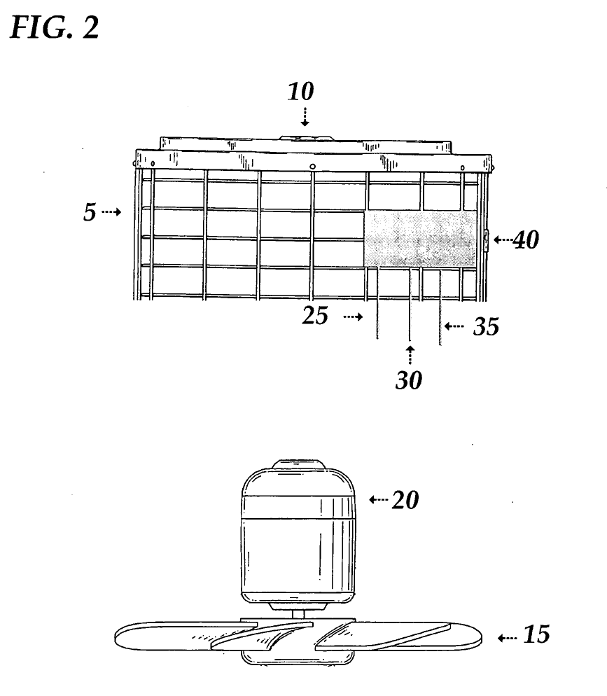

FIG. 3 is a perspective with the generator and fan inside the protective housing in FIGS. 1 & 2 being fitted over the mechanical source with electrical connections.

FIG. 4 is similar to FIG. 3 and is a perspective with the generator and fan inside the protective housing in FIGS. 1 & 2 being fitted over the mechanical source with electrical connections.

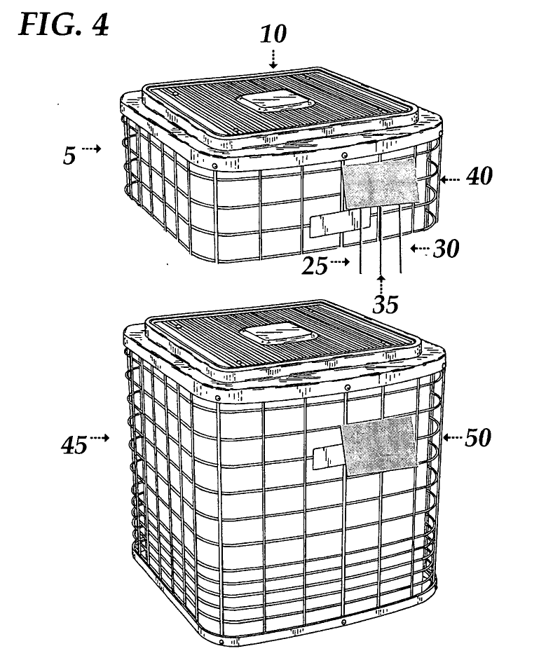

### NUMBERING SUMMARY

5-Protective Housing Structure

10-Connection Point For Protective Housing And Generator

15-Fan Blades

20-Generator

25-Negative Wire From Charge Controller/Power Inverter

30-Positive Wire From Charge Controller/Power Inverter

35-Neutral Wire From Charge Controller/Power Inverter

40-Charge Controller/Power Inverter

45-Mechanical Source

50-Mechanical Source Connection Point From Charge Controller/Power Inverter

### DETAILED DESCRIPTION OF THE PREFERRED EMBODIMENTS

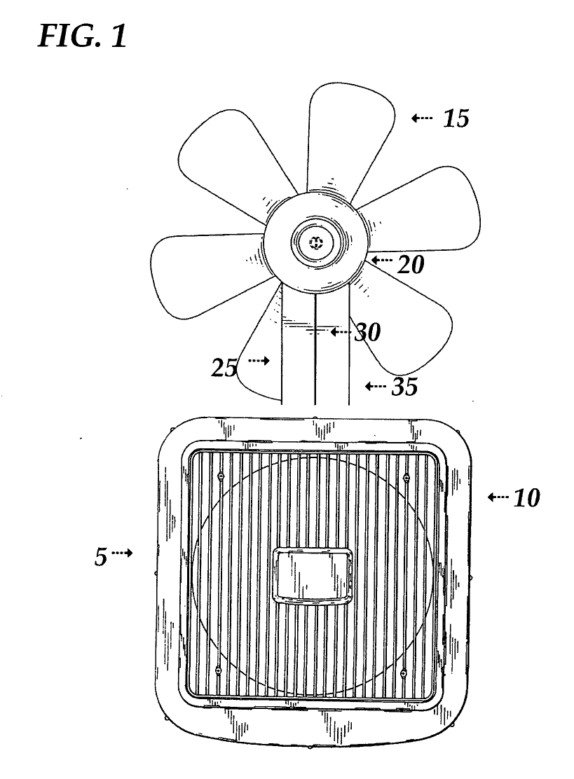

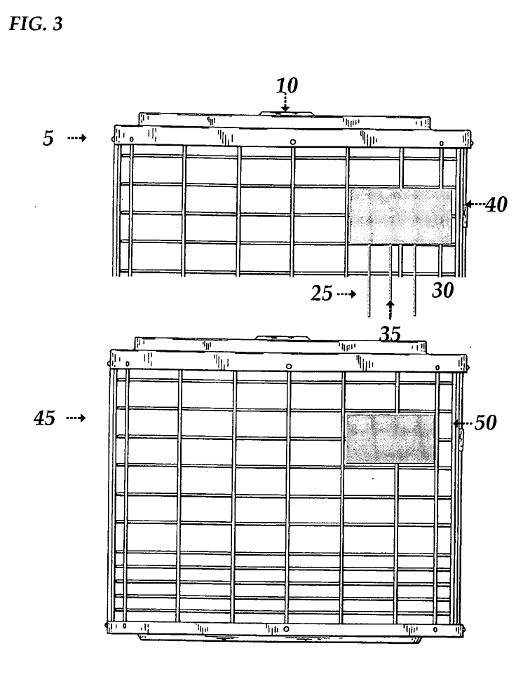

Referring now to the drawings, in FIG. 1 there shows the generator 20 which will create the renewable energy when the fan blades 15 are rotated by the mechanical source 45 in FIGS. 3 & 4 is in operation forcing the venting, flow, wind or exhaust towards the generator 20 and fan blades 15.

The protective housing structure 5 covers the generator 20 and fan blades 15 and connects with generator 20 at the connection points 10 to hold it steady and in place to be placed over top of the mechanical source 45 at a distance to be most efficient to collect the venting, exhaust, discharge or wind to make renewable energy.

The drawings in FIGS. 3 & 4 show the housing structure 5 with the generator 20 and fan blades 15 has the electric wires from the generator 20 connected to the charge controller and power inverter 40 to transfer the renewable energy created to send to the mechanical source connection point 50. This energy is manufactured and used in real time, immediately to decrease the demand from the mechanical source to function.

I claim:

1. A renewable energy electric power generation system comprising of a renewable energy generator to collect rotational movement from a turbine fan which collects the energy from the movement of the venting, flow, wind, exhaust or discharge created by a mechanical source to create continuous electric energy when the said source is in operation.

2. Said system stated in claim 1 captures the energy created from the venting, flow, discharge, exhaust, or wind created by any and all mechanical source to produce renewable energy with the said sources movement of said discharge through the said system to create renewable energy every time said source is in operation.

3. The renewable energy is collected by an electrical generator which is retrofitted over the top of the said discharge area of the mechanical source and/or incorporated as part of the mechanical sources during manufacture to collect the discharge from said source when in operation which results in the said system to rotate and create renewable energy which will be returned to the said mechanical source for immediate operational energy use, to a battery storage bank or directly to the power grid. Said system is fitted to a distance to maximize the renewable energy efficiency, created by the flow, discharge, wind, venting, exhaust from the said source.

4. A renewable energy electric power generation system will return the renewable energy directly to the mechanical source, to a energy collection system such as battery bank or the like, directly to the mechanical source or to the power grid, with direct electrical wiring to do so efficiently. Said system creates renewable energy every time the mechanical source is in operation and be returned to said source immediately.

5. A renewable energy electric power generation system comprises of electrical wiring which prevents energy back flow and movement of useful renewable electrical energy being directly used by said source to minimize the said sources energy consumption in a stand alone basis and will not require major power lines or energy transfer stations and creates the largest renewable energy field, with the least expense both economically and physical detriment to the environment when the system is retrofit or incorporated to the said mechanical source.
